(19) United States
(12) Patent Application Publication
(10) Pub. No.: US 2018/0367346 A1
(43) Pub. Date: Dec. 20, 2018

(54) Cross-Link Interference Measurement In Mobile Communications

(71) Applicant: MediaTek Inc., Hsinchu City (TW)

(72) Inventors: Bo-Si Chen, Hsinchu City (TW); Weidong Yang, San Diego, CA (US)

(21) Appl. No.: 16/010,363

(22) Filed: Jun. 15, 2018

Related U.S. Application Data
(63) Continuation-in-part of application No. 15/970,881, filed on May 4, 2018.
(60) Provisional application No. 62/521,201, filed on Jun. 16, 2017.

(51) Int. Cl. H04L 25/02; H04L 5/00; H04L 1/00; H04B 17/345

(52) U.S. Cl. CPC H04L 25/0224; H04B 17/345; H04L 1/0026; H04L 5/0048

(57) ABSTRACT

Various solutions for cross-link interference (CLI) measurement with respect to user equipment and network apparatus in mobile communications are described. An apparatus may receive a configuration indicating a zero power (ZP) sounding reference signal (SRS) from a transmit/receive point (TRP). The apparatus may receive an SRS from a user equipment (UE). The apparatus may perform CLI measurement according to the SRS from the UE with the ZP SRS from the TRP.

### CROSS REFERENCE TO RELATED PATENT APPLICATION(S)

The present disclosure is part of a non-provisional application claiming the priority benefit of U.S. Patent Application No. 62/521,201, filed on 16 Jun. 2017, and is a continuation-in-part (CIP) of U.S. patent application Ser. No. 15/970,881, filed 4 May 2018. Contents of the aforementioned patent documents are herein incorporated by reference in their entirety.

### TECHNICAL FIELD

The present disclosure is generally related to mobile communications and, more particularly, to cross-link interference (CLI) measurement with respect to user equipment and network apparatus in mobile communications.

### BACKGROUND

Unless otherwise indicated herein, approaches described in this section are not prior art to the claims listed below and are not admitted as prior art by inclusion in this section.

In Long-Term Evolution (LTE), New Radio (NR) or a newly developed wireless communication system, cross-link interference (CLI) may occur among a plurality of nodes. Each node in the wireless network may be a network apparatus (e.g., a transmit/receive point (TRP)) or a communication apparatus (e.g., a user equipment (UE)). A UE may be engaged in communication with a TRP, another UE, or both, at a given time. Thus, the cross-link interference measurements may associate three types of node pairs: TRP-TRP, TRP-UE and UE-UE.

In order to avoid or mitigate the CLI, CLI measurements may be needed. For example, UE-UE or TRP-TRP interference measurements may become important and necessary. For performing the CLI measurement, some reference signals may be needed for measurements by a node. For example, a channel state information-reference signal (CSI-RS) may be used for TRP-TRP interference measurements. A sounding reference signal (SRS) may be used for UE-UE interference measurements.

Accordingly, which nodes or devices should transmit or receive the reference signals and perform CLI measurements may become important for interference management. In order to facilitate CLI measurements, it is needed to provide proper mechanisms and coordination to transmit and receive the reference signals.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to CLI measurement with respect to user equipment and network apparatus in mobile communications.

In one aspect, a method may involve an apparatus receiving a configuration indicating a zero power (ZP) SRS from a TRP. The method may also involve the apparatus receiving an SRS from a UE. The method may further involve the apparatus performing CLI measurement according to the SRS from the UE with the ZP SRS from the TRP.

In one aspect, a method may involve an apparatus transmitting a configuration indicating a ZP CSI-RS to a UE. The method may also involve the apparatus receiving a CSI-RS from a TRP. The method may further involve the apparatus performing CLI measurement according to the CSI-RS from the TRP with the ZP TRP from the UE.

In one aspect, an apparatus may comprise a transceiver capable of wirelessly communicating with a plurality of nodes of a wireless network. The apparatus may also comprise a processor communicatively coupled to the transceiver. The processor may be capable of receiving a configuration indicating a ZP SRS from a TRP. The processor may also be capable of receiving an SRS from a UE. The processor may further be capable of performing CLI measurement according to the SRS from the UE with the ZP SRS from the TRP.

In one aspect, an apparatus may comprise a transceiver capable of wirelessly communicating with a plurality of nodes of a wireless network. The apparatus may also comprise a processor communicatively coupled to the transceiver. The processor may be capable of transmitting a configuration indicating a ZP CSI-RS to a UE. The processor may also be capable of receiving a CSI-RS from a TRP. The processor may further be capable of performing CLI measurement according to the CSI-RS from the TRP with the ZP TRP from the UE.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a block diagram of an example communication apparatus and an example network apparatus in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to CLI measurement with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In LTE, NR or a newly developed wireless communication system, CLI may occur among a plurality of nodes. Each node in the wireless network may be a network apparatus (e.g., TRP) or a communication apparatus (e.g., UE). A UE may be engaged in communication with a TRP, another UE, or both, at a given time. Thus, the cross-link interference measurements may associate three types of node pairs: TRP-TRP, TRP-UE and UE-UE. Herein, a TRP may be an eNB in an LTE-based network or a gNB in a 5G/NR network.

In order to management or mitigate the CLI, CLI measurements may be needed. For example, UE-UE, TRP-TRP or TRP-UE interference measurements may become important and necessary. For performing the CLI measurement, some reference signals may be needed for measurements by a node. For example, a CSI-RS may be used for TRP-TRP interference measurements and an SRS may be used for UE-UE interference measurements. The signal used for the CLI measurement may be classified as the CLI reference signal (RS). In other words, the CLI RS may comprise the CSI-RS or the SRS.

To support CLI measurement and keep the symmetry of downlink and uplink slot structure, it may have benefits to make the SRS and the CSI-RS share the same time-frequency resources and have the similar pattern and sequence design. However, in a case that the wireless communication system does not support CSI-RS and SRS co-design, to facilitate CLI measurement, the CSI-RS may also be used for TRP-UE or UE-UE interference measurements. The SRS may also be used for TRP-UE or TRP-TRP interference measurements. In other words, the UE may also be able to transmit the CSI-RS and the TRP may also be able to transmit the SRS for the CLI measurement.

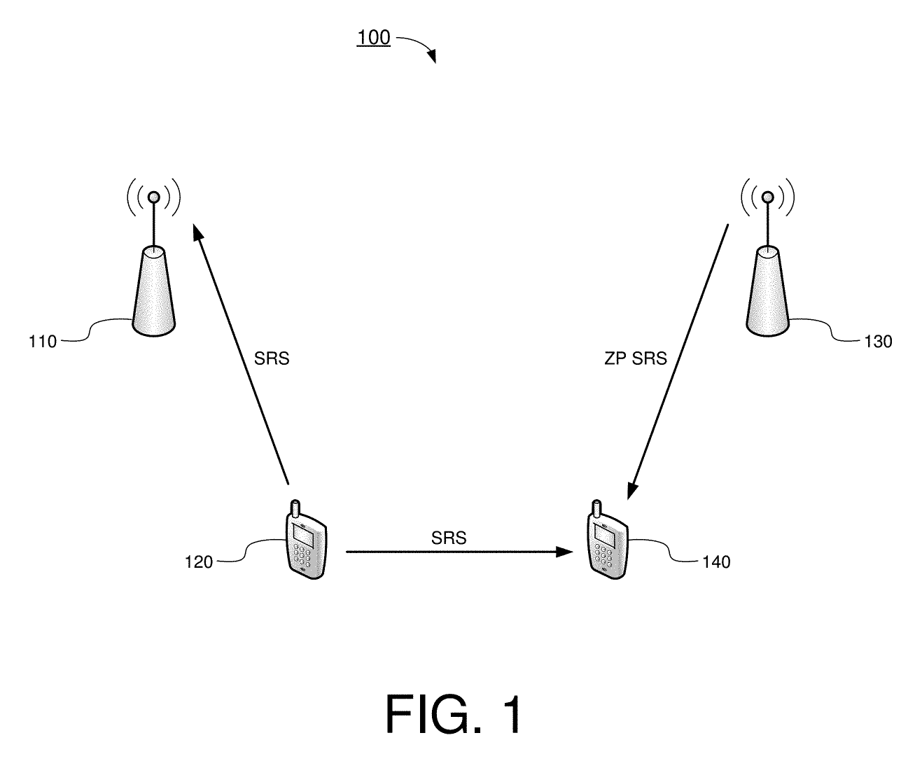

FIG. 1 illustrates an example scenario 100 under schemes in accordance with implementations of the present disclosure. Scenario 100 involves a plurality of UEs (e.g., UE 120 and 140) and a plurality of TRPs (e.g., TRP 110 and 130), which may be a part of a wireless communication network (e.g., an LTE network, an LTE-Advanced network, an LTE-Advanced Pro network, a 5G network, an NR network, an IoT network or an NB-IoT network). UE 120 may be served by TRP 110. UE 140 may be served by TRP 130. To facilitate UE-UE interference measurement, TRP 110 and TRP 130 may be configured to exchange the timing of the CLI measurement slots first. The CLI measurement slots may be used by the UE or the TRP to perform the CLI measurement.

In a case that TRP 130 determines to have UE 140 measure the CLI, TRP 130 may be configured to rate match a zero power (ZP) SRS to UE 140. Specifically, TRP 110 may configure UE 120 to transmit the SRS in a CLI measurement slot. UE 120 may be configured to transmit the SRS in the CLI measurement slot. TRP 110 may inform the timing of the CLI measurement slot to TRP 130. TRP 130 may be configured to rate match a ZP SRS to UE 140 in the CLI measurement slot. In other words, TRP 130 may be configured not to transmit signals to UE 140 in the measurement slot. TRP 130 may further transmit a configuration to inform UE 140 the occurrence of the ZP SRS. UE 140 may be configured to receive the configuration indicating the ZP SRS in the CLI measurement slot. Thus, UE 140 may be configured to receive the SRS from UE 120 with the ZP SRS from TRP 130. UE 140 may be configured to perform the CLI measurement according to the SRS from UE 120 with the ZP SRS from TRP 130. Accordingly, UE 140 may be able to measure the uncontaminated SRS in the CLI measurement slot. After performing the CLI measurement, UE 140 may further be configured to report the measurement result to TRP 130 or determine whether to transmit uplink data according to the measurement result.

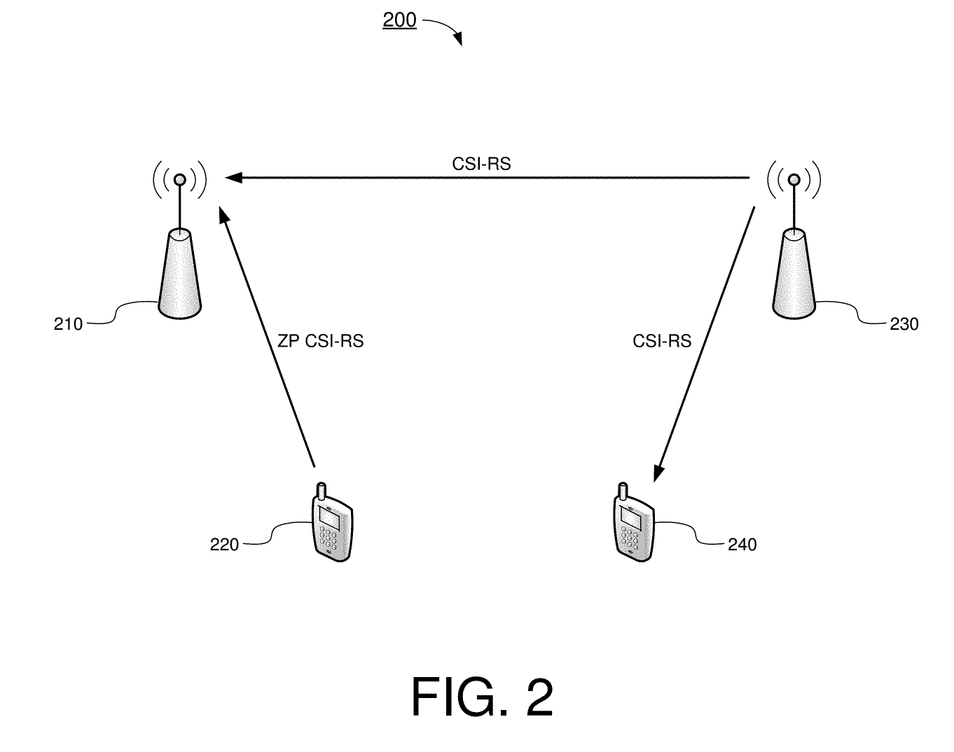

FIG. 2 illustrates an example scenario 200 under schemes in accordance with implementations of the present disclosure. Scenario 200 involves a plurality of UEs (e.g., UE 220 and 240) and a plurality of TRPs (e.g., TRP 210 and 230), which may be a part of a wireless communication network (e.g., an LTE network, an LTE-Advanced network, an LTE-Advanced Pro network, a 5G network, an NR network, an IoT network or an NB-IoT network). UE 220 may be served by TRP 210. UE 240 may be served by TRP 230. To facilitate TRP-TRP interference measurement, TRP 110 and TRP 130 may be configured to exchange the timing of the CLI measurement slots first. The CLI measurement slots may be used by the UE or the TRP to perform the CLI measurement.

In a case that TRP 210 determines to measure the CLI, TRP 210 may configure UE 220 to rate match a ZP CSI-RS to TRP 210. Specifically, TRP 230 may be configured to transmit the CSI-RS in a CLI measurement slot. TRP 230 may inform the timing of the CLI measurement slot to TRP 210 first. TRP 210 may be configured to transmit a configuration to inform UE 220 to rate match a ZP CSI-RS in the CLI measurement slot. UE 220 may be configured to receive the configuration indicating the ZP CSI-RS from TRP 210. UE 220 may be configured to rate match the ZP CSI-RS to TRP 210 in the CLI measurement slot. In other words, UE 220 may be configured not to transmit signals to TRP 210 in the measurement slot. Thus, TRP 210 may be able to receive the CSI-RS from TRP 230 with the ZP CSI-RS from UE 220. TRP 210 may be configured to perform the CLI measurement according to the CSI-RS from TRP 230 with the ZP CSI-RS from UE 220. Accordingly, TRP 210 may be able to measure the uncontaminated CSI-RS in the CLI measurement slot. After performing the CLI measurement, TRP 210 may further be configured to determine whether to transmit downlink data or determine its scheduling strategy according to the measurement result.

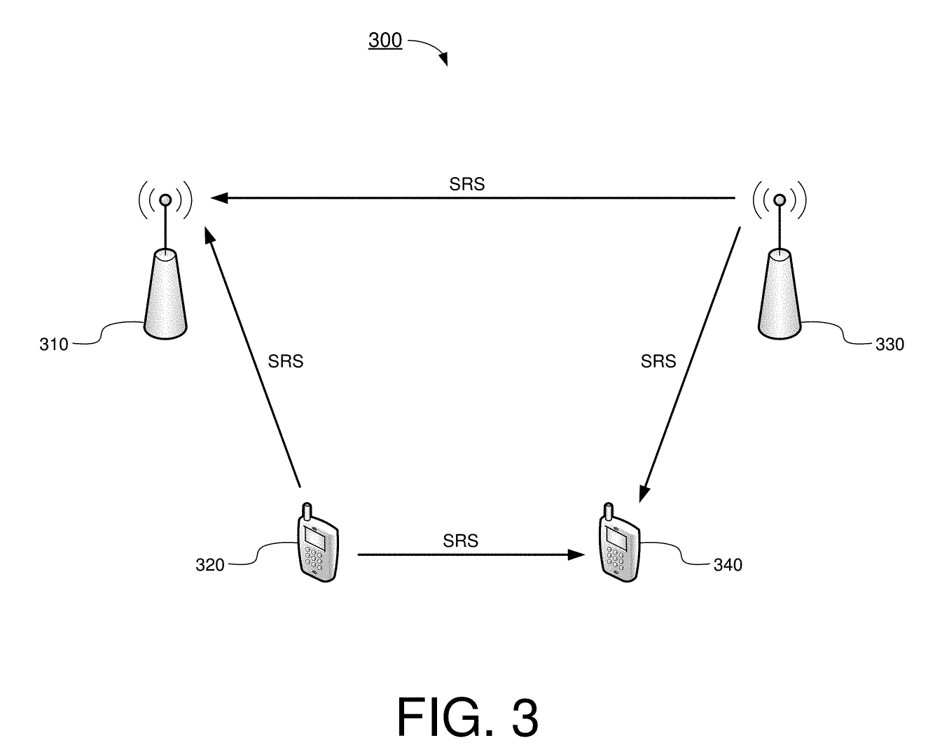

FIG. 3 illustrates an example scenario 300 under schemes in accordance with implementations of the present disclosure. Scenario 300 involves a plurality of UEs (e.g., UE 320 and 340) and a plurality of TRPs (e.g., TRP 310 and 330), which may be a part of a wireless communication network (e.g., an LTE network, an LTE-Advanced network, an LTE-Advanced Pro network, a 5G network, an NR network, an IoT network or an NB-IoT network). UE 320 may be served by TRP 310. UE 340 may be served by TRP 330. To facilitate CLI measurement, the TRP may be able to transmit the SRS. For example, TRP 330 may be configured to transmit the SRS to UE 340 and TRP 310.

As showed in FIG. 3, UE 340 may be configured to receive a first SRS from TRP 330. UE 340 may be configured to receive a second SRS from UE 320. Assuming that good cross-correlation property is held between the first SRS and the second SRS, UE 340 may be configured to perform downlink channel measurement according to the first SRS from TRP 330 and UE-UE interference measurement according to the second SRS from UE 320 at the same time.

Similarly, TRP 310 may be configured to receive a first SRS from TRP 330. TRP 310 may be configured to receive a second SRS from UE 320. Assuming that good cross-correlation property is held between the first SRS and the second SRS, TRP 310 may be configured to perform TRP-TRP interference measurement according to the first SRS from TRP 330 and uplink channel measurement according to the second SRS from UE 320 at the same time.

Since there may be too many UEs in the wireless communication network, to keep orthogonality, UE-specific reference signals may not be feasible. Thus, the reference signal transmitted from the UE should also be cell-specific. The information of which device (e.g., UE or TRP) transmits the reference signals (e.g., SRS or CSI-RS) should also be exchanged among TRPs. For example, when measuring the CLI, UE 340 may not know that the SRS is transmitted from UE 320 or TRP 310. UE 320 may be configured to just report the interference strength and the cell-specific scrambling sequence to TRP 330. TRP 330 may be able to determine that the interference is from UE 320 based on the information from TRP 310 and determine its scheduling strategy accordingly.

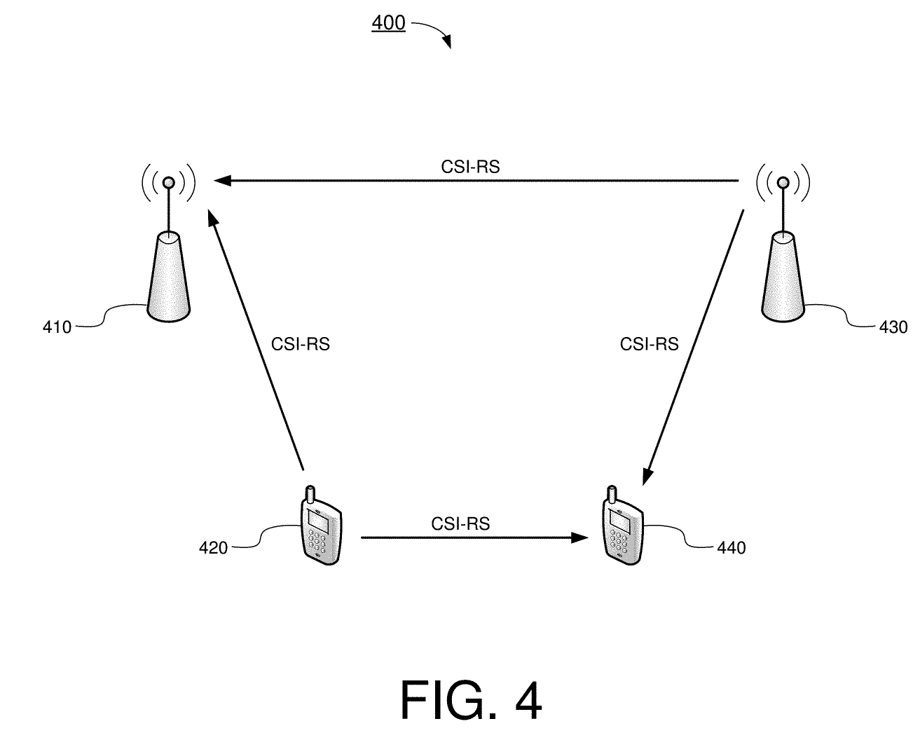

FIG. 4 illustrates an example scenario 400 under schemes in accordance with implementations of the present disclosure. Scenario 400 involves a plurality of UEs (e.g., UE 420 and 440) and a plurality of TRPs (e.g., TRP 410 and 430), which may be a part of a wireless communication network (e.g., an LTE network, an LTE-Advanced network, an LTE-Advanced Pro network, a 5G network, an NR network, an IoT network or an NB-IoT network). UE 420 may be served by TRP 410. UE 440 may be served by TRP 430. To facilitate CLI measurement, the UE may be able to transmit the CSI-RS. For example, UE 420 may be configured to transmit the CSI-RS to TRP 410 and UE 440.

As showed in FIG. 4, UE 440 may be configured to receive a first CSI-RS from TRP 430. UE 440 may be configured to receive a second CSI-RS from UE 420. Assuming that good cross-correlation property is held between the first CSI-RS and the second CSI-RS, UE 340 may be configured to perform downlink channel measurement according to the first CSI-RS from TRP 430 and UE-UE interference measurement according to the second CSI-RS from UE 420 at the same time.

Similarly, TRP 410 may be configured to receive a first CSI-RS from TRP 430. TRP 410 may be configured to receive a second CSI-RS from UE 420. Assuming that good cross-correlation property is held between the first CSI-RS and the second CSI-RS, TRP 410 may be configured to perform TRP-TRP interference measurement according to the first CSI-RS from TRP 430 and uplink channel measurement according to the second CSI-RS from UE 420 at the same time.

### Illustrative Implementations

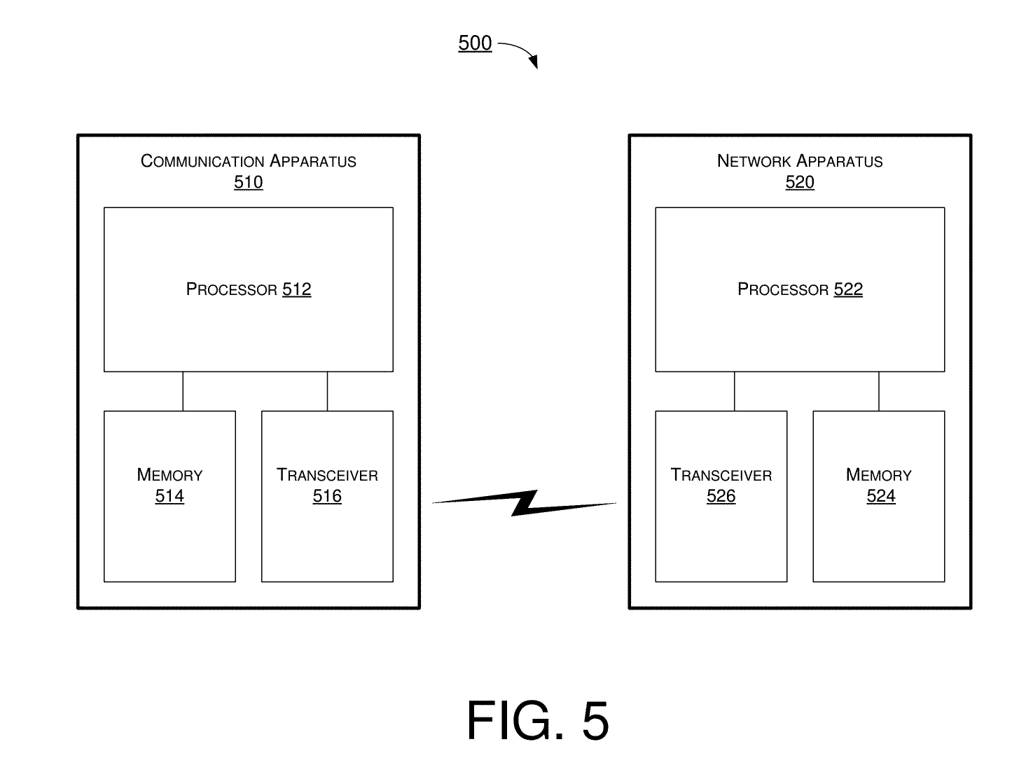

FIG. 5 illustrates an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to CLI measurement with respect to user equipment and network apparatus in wireless communications, including scenarios 100, 200, 300 and 400 described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT or NB-IoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, or one or more complex-instruction-set-computing (CISC) processors. Communication apparatus 510 may include at least some of those components shown in FIG. 5 such as a processor 512, for example. communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a TRP, a base station, a small cell, a router or a gateway. For instance, network apparatus 520 may be implemented in an eNodeB in an LTE, LTE-Advanced or LTE-Advanced Pro network or in a gNB in a 5G, NR, IoT or NB-IoT network. Alternatively, network apparatus 520 may be implemented in the form of one or more IC chips such as, for example and without limitation, one or more single-core processors, one or more multi-core processors, or one or more CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including power consumption reduction in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, when network apparatus 520 determines to have communication apparatus 510 measure the CLI, processor 522 may be configured to rate match a ZP SRS to communication apparatus 510. Specifically, communication apparatus 510 may be served by network apparatus 520. There may be a neighbor TRP and a neighbor UE. The neighbor TRP may configure the neighbor UE to transmit the SRS in a CLI measurement slot. The neighbor UE may be configured to transmit the SRS in the CLI measurement slot. The neighbor TRP may inform the timing of the CLI measurement slot to network apparatus 520. Processor 522 may be configured to rate match a ZP SRS to communication apparatus 510 in the CLI measurement slot. In other words, processor 522 may be configured not to transmit signals to communication apparatus 510 in the measurement slot. Processor 522 may further transmit, via transceiver 526, a configuration to inform communication apparatus 510 the occurrence of the ZP SRS. Processor 512 may be configured to receive, via transceiver 516, the configuration indicating the ZP SRS in the CLI measurement slot. Thus, processor 512 may be configured to receive the SRS from the neighbor UE with the ZP SRS from network apparatus 520. Processor 512 may be configured to perform the CLI measurement according to the SRS from the neighbor UE with the ZP SRS from network apparatus 520. Accordingly, processor 512 may be able to measure the uncontaminated SRS in the CLI measurement slot. After performing the CLI measurement, processor 512 may further be configured to report the measurement result to network apparatus 520 or determine whether to transmit uplink data according to the measurement result.

In some implementations, when network apparatus 520 determines to measure the CLI, processor 522 may configure communication apparatus 510 to rate match a ZP CSI-RS to network apparatus 520. Specifically, communication apparatus 510 may be served by network apparatus 520. There may be a neighbor TRP and a neighbor UE. The neighbor TRP may transmit the CSI-RS in a CLI measurement slot. The neighbor TRP may inform the timing of the CLI measurement slot to network apparatus 520 first. Processor 522 may be configured to transmit a configuration, via transceiver 526, to inform communication apparatus 510 to rate match a ZP CSI-RS in the CLI measurement slot. Processor 512 may be configured to receive the configuration indicating the ZP CSI-RS from network apparatus 520. Processor 512 may be configured to rate match the ZP CSI-RS to network apparatus 520 in the CLI measurement slot. In other words, processor 512 may be configured not to transmit signals to network apparatus 520 in the measurement slot. Thus, processor 522 may be able to receive the CSI-RS from the neighbor TRP with the ZP CSI-RS from communication apparatus 510. Processor 522 may be configured to perform the CLI measurement according to the CSI-RS from the neighbor TRP with the ZP CSI-RS from communication apparatus 510. Accordingly, processor 522 may be able to measure the uncontaminated CSI-RS in the CLI measurement slot. After performing the CLI measurement, processor 522 may further be configured to determine whether to transmit downlink data or determine its scheduling strategy according to the measurement result.

In some implementations, network apparatus 520 may be able to transmit, via transceiver 526, the SRS. For example, processor 522 may be configured to transmit the SRS to communication apparatus 510 and the neighbor TRP. Processor 512 may be configured to receive, via transceiver 516, a first SRS from network apparatus 520. Processor 512 may be configured to receive, via transceiver 516, a second SRS from the neighbor UE. Processor 512 may be configured to perform downlink channel measurement according to the first SRS from network apparatus 520 and UE-UE interference measurement according to the second SRS from the neighbor UE at the same time.

In some implementations, processor 522 may be configured to receive, via transceiver 526, a first SRS from the neighbor TRP. Processor 522 may be configured to receive, via transceiver 526, a second SRS from communication apparatus 510. Processor 522 may be configured to perform TRP-TRP interference measurement according to the first SRS from the neighbor TRP and uplink channel measurement according to the second SRS from communication apparatus 510 at the same time.

In some implementations, processor 522 may be configured to receive, via transceiver 526, the information of which device transmits the reference signals (e.g., SRS or CSI-RS) from other TRPs. When measuring the CLI, processor 512 may not know that the SRS is transmitted from the neighbor UE or the neighbor TRP. Processor 512 may be configured to just report the interference strength and the cell-specific scrambling sequence to network apparatus 520. Processor 522 may be able to determine that the interference is from communication apparatus 510 based on the information from the neighbor TRP and determine its scheduling strategy accordingly.

In some implementations, communication apparatus 510 may be able to transmit, via transceiver 516, the CSI-RS. For example, processor 512 may be configured to transmit the CSI-RS to network apparatus 520 and the neighbor UE. Processor 512 may be configured to receive, via transceiver 516, a first CSI-RS from network apparatus 520. Processor 512 may be configured to receive, via transceiver 516, a second CSI-RS from the neighbor UE. Processor 512 may be configured to perform downlink channel measurement according to the first CSI-RS from network apparatus 520 and UE-UE interference measurement according to the second CSI-RS from the neighbor UE at the same time.

In some implementations, processor 522 may be configured to receive, via transceiver 526, a first CSI-RS from the neighbor TRP. Processor 522 may be configured to receive, via transceiver 526, a second CSI-RS from communication apparatus 510. Processor 522 may be configured to perform TRP-TRP interference measurement according to the first CSI-RS from the neighbor TRP and uplink channel measurement according to the second CSI-RS from communication apparatus 510 at the same time.

### Illustrative Processes

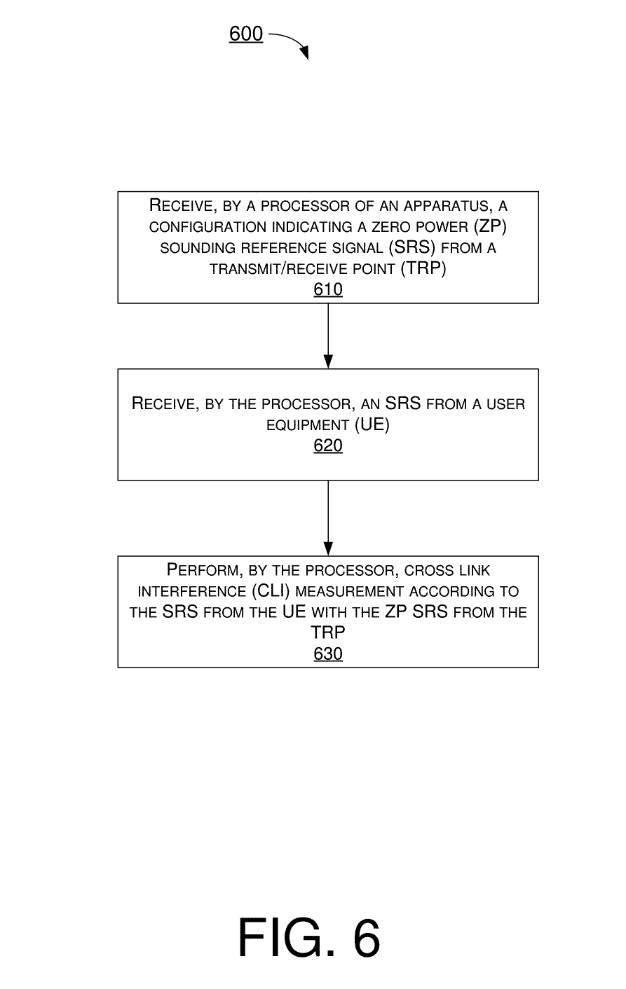

FIG. 6 illustrates an example process 600 in accordance with an implementation of the present disclosure. Process 600 may be an example implementation of scenarios 100 and 300, whether partially or completely, with respect to CLI measurement in accordance with the present disclosure. Process 600 may represent an aspect of implementation of features of communication apparatus 510. Process 600 may include one or more operations, actions, or functions as illustrated by one or more of blocks 610, 620 and 630. Although illustrated as discrete blocks, various blocks of process 500 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At 610, process 600 may involve processor 512 of apparatus 510 receiving a configuration indicating a ZP SRS from a TRP. Process 600 may proceed from 610 to 620.

At 620, process 600 may involve processor 512 receiving an SRS from a UE. Process 600 may proceed from 620 to 630.

At 630, process 600 may involve processor 512 performing CLI measurement according to the SRS from the UE with the ZP SRS from the TRP.

In some implementations, process 600 may involve processor 512 receiving a first SRS from the TRP. Process 600 may also involve processor 512 receiving a second SRS from the UE. Process 600 may further involve processor 512 performing downlink channel measurement according to the first SRS and UE-UE interference measurement according to the second SRS at the same time.

In some implementations, process 600 may involve processor 512 receiving a first CSI-RS from the TRP. Process 600 may also involve processor 512 receiving a second CSI-RS from the UE. Process 600 may further involve processor 512 performing the downlink channel measurement according to the first CSI-RS and the UE-UE interference measurement according to the second CSI-RS at the same time.

In some implementations, process 600 may involve processor 512 rate matching a ZP CSI-RS to the TRP.

In some implementations, process 600 may involve processor 512 transmitting a first CSI-RS to the TRP. Process 600 may also involve processor 512 transmitting a second CSI-RS to the UE.

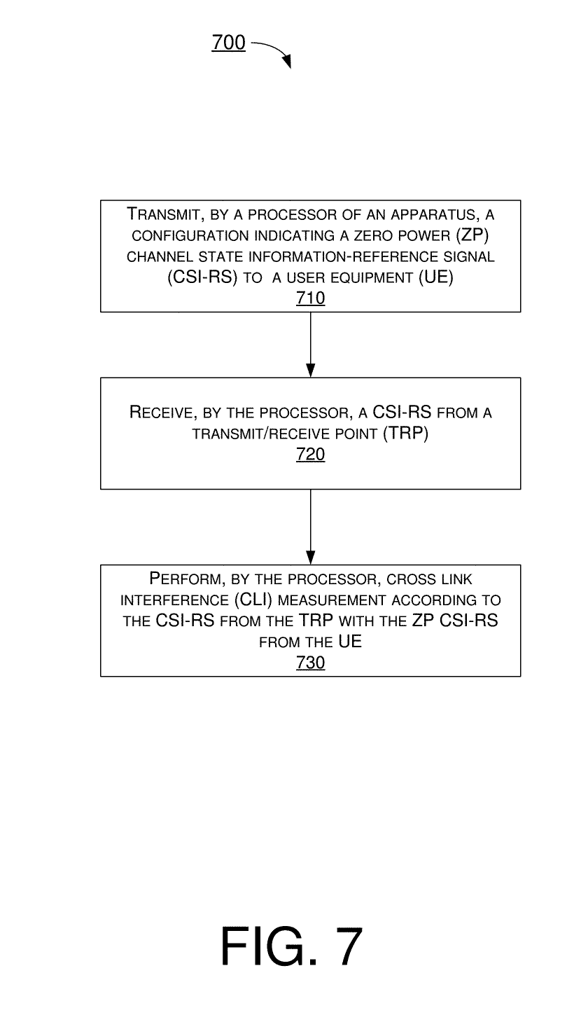

FIG. 7 illustrates an example process 700 in accordance with an implementation of the present disclosure. Process 700 may be an example implementation of scenarios 200 and 400, whether partially or completely, with respect to CLI measurement in accordance with the present disclosure. Process 700 may represent an aspect of implementation of features of network apparatus 520. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by network apparatus 520 or any suitable base stations or network nodes. Solely for illustrative purposes and without limitation, process 700 is described below in the context of network apparatus 520. Process 700 may begin at block 710.

At 710, process 700 may involve processor 522 of apparatus 520 transmitting a configuration indicating a ZP CSI-RS to a UE. Process 700 may proceed from 710 to 720.

At 720, process 700 may involve processor 522 receiving a CSI-RS from a TRP. Process 700 may proceed from 720 to 730.

At 730, process 700 may involve processor 522 performing CLI measurement according to the CSI-RS from the TRP with the ZP TRP from the UE.

In some implementations, process 700 may involve processor 522 receiving, by the processor, a first SRS from the UE. Process 700 may also involve processor 522 receiving a second SRS from the TRP. Process 700 may further involve processor 522 performing uplink channel measurement according to the first SRS and TRP-TRP interference measurement according to the second SRS at the same time.

In some implementations, process 700 may involve processor 522 receiving a first CSI-RS from the UE. Process 700 may also involve processor 522 receiving a second CSI-RS from the TRP. Process 700 may further involve processor 522 performing the uplink channel measurement according to the first CSI-RS and the TRP-TRP interference measurement according to the second CSI-RS at the same time.

In some implementations, process 700 may involve processor 522 rate matching a ZP SRS to the UE.

In some implementations, process 700 may involve processor 522 transmitting a first SRS to the UE. Process 700 may also involve processor 522 transmitting a second SRS to the TRP.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration indicating a zero power (ZP) sounding reference signal (SRS) from a transmit/receive point (TRP);
receiving, by the processor, an SRS from a user equipment (UE); and
performing, by the processor, cross-link interference (CLI) measurement according to the SRS from the UE with the ZP SRS from the TRP.

2. The method of claim 1, further comprising:
receiving, by the processor, a first SRS from the TRP;
receiving, by the processor, a second SRS from the UE; and
performing, by the processor, downlink channel measurement according to the first SRS and UE-UE interference measurement according to the second SRS at the same time.

3. The method of claim 1, further comprising:
receiving, by the processor, a first channel state information-reference signal (CSI-RS) from the TRP;
receiving, by the processor, a second CSI-RS from the UE; and
performing, by the processor, the downlink channel measurement according to the first CSI-RS and the UE-UE interference measurement according to the second CSI-RS at the same time.

4. The method of claim 1, further comprising:
rate matching, by the processor, a ZP channel state information-reference signal (CSI-RS) to the TRP.

5. The method of claim 1, further comprising:
transmitting, by the processor, a first channel state information-reference signal (CSI-RS) to the TRP; and
transmitting, by the processor, a second CSI-RS to the UE.

6. A method, comprising:
transmitting, by a processor of an apparatus, a configuration indicating a zero power (ZP) channel state information-reference signal (CSI-RS) to a user equipment (UE);
receiving, by the processor, a CSI-RS from a transmit/receive point (TRP); and
performing, by the processor, cross-link interference (CLI) measurement according to the CSI-RS from the TRP with the ZP TRP from the UE.

7. The method of claim 6, further comprising:
receiving, by the processor, a first sounding reference signal (SRS) from the UE;
receiving, by the processor, a second SRS from the TRP; and
performing, by the processor, uplink channel measurement according to the first SRS and TRP-TRP interference measurement according to the second SRS at the same time.

8. The method of claim 6, further comprising:
receiving, by the processor, a first CSI-RS from the UE;
receiving, by the processor, a second CSI-RS from the TRP; and
performing, by the processor, the uplink channel measurement according to the first CSI-RS and the TRP-TRP interference measurement according to the second CSI-RS at the same time.

9. The method of claim 6, further comprising:
rate matching, by the processor, a ZP sounding reference signal (SRS) to the UE.

10. The method of claim 6, further comprising:
transmitting, by the processor, a first sounding reference signal (SRS) to the UE; and
transmitting, by the processor, a second SRS to the TRP.

11. An apparatus, comprising:
a transceiver capable of wirelessly communicating with a plurality of nodes of a wireless network; and
a processor communicatively coupled to the transceiver, the processor capable of:
receiving, via the transceiver, a configuration indicating a zero power (ZP) sounding reference signal (SRS) from a transmit/receive point (TRP);
receiving, via the transceiver, an SRS from a user equipment (UE); and
performing cross-link interference (CLI) measurement according to the SRS from the UE with the ZP SRS from the TRP.

12. The apparatus of claim 11, wherein the processor is further capable of:
receiving, via the transceiver, a first SRS from the TRP;
receiving, via the transceiver, a second SRS from the UE; and
performing downlink channel measurement according to the first SRS and UE-UE interference measurement according to the second SRS at the same time.

13. The apparatus of claim 11, wherein the processor is further capable of:
receiving, via the transceiver, a first channel state information-reference signal (CSI-RS) from the TRP;
receiving, via the transceiver, a second CSI-RS from the UE; and
performing the downlink channel measurement according to the first CSI-RS and the UE-UE interference measurement according to the second CSI-RS at the same time.

14. The apparatus of claim 11, wherein the processor is further capable of:
rate matching a ZP channel state information-reference signal (CSI-RS) to the TRP.

15. The apparatus of claim 11, wherein the processor is further capable of:
transmitting, via the transceiver, a first channel state information-reference signal (CSI-RS) to the TRP; and
transmitting, via the transceiver, a second CSI-RS to the UE.

16. An apparatus, comprising:
a transceiver capable of wirelessly communicating with a plurality of nodes of a wireless network; and
a processor communicatively coupled to the transceiver, the processor capable of:
transmitting, via the transceiver, a configuration indicating a zero power (ZP) channel state information-reference signal (CSI-RS) to a user equipment (UE);
receiving, via the transceiver, a CSI-RS from a transmit/receive point (TRP); and
performing cross-link interference (CLI) measurement according to the CSI-RS from the TRP with the ZP TRP from the UE.

17. The apparatus of claim 16, wherein the processor is further capable of:
receiving, via the transceiver, a first sounding reference signal (SRS) from the UE;
receiving, via the transceiver, a second SRS from the TRP; and
performing uplink channel measurement according to the first SRS and TRP-TRP interference measurement according to the second SRS at the same time.

18. The apparatus of claim 16, wherein the processor is further capable of:
receiving, via the transceiver, a first CSI-RS from the UE;
receiving, via the transceiver, a second CSI-RS from the TRP; and
performing the uplink channel measurement according to the first CSI-RS and the TRP-TRP interference measurement according to the second CSI-RS at the same time.

19. The apparatus of claim 16, wherein the processor is further capable of:
rate matching a ZP sounding reference signal (SRS) to the UE.

20. The apparatus of claim 16, wherein the processor is further capable of:
transmitting, via the transceiver, a first sounding reference signal (SRS) to the UE; and
transmitting, via the transceiver, a second SRS to the TRP.
